(19) United States
(12) Patent Application Publication
(10) Pub. No.: US 2004/0267781 A1
(43) Pub. Date: Dec. 30, 2004

(54) WEB-BASED SYSTEM AND METHOD FOR MULTI-LAYERED DISPLAY OF DYNAMIC AND STATIC OBJECTS

(75) Inventors: Roman Smolgovsky, Foster City, CA (US); Maurice Bailey, Los Gatos, CA (US)

Correspondence Address: SQUIRE, SANDERS & DEMPSEY L.L.P, 600 HANSEN WAY, PALO ALTO, CA, 94304-1043, US

(73) Assignee: FLYTECOMM, INC., Mountain View

(21) Appl. No.: 10/709,711

(22) Filed: May 24, 2004

Related U.S. Application Data
(60) Provisional application No. 60/472,943, filed on May 23, 2003.

(51) Int. Cl. G06F 17/00

(52) U.S. Cl. 707/100

(57) ABSTRACT

Embodiments of the invention enable the display of objects in relation to each other through the use of multiple layers. The display can be refreshed without refreshing the screen; only individual layers requiring updating are refreshed.

### PRIORITY REFERENCE TO PRIOR APPLICATIONS

This application claims benefit of and incorporates by reference U.S. patent application Ser. No. 60/472,943, entitled “Multi-Layered Graphical Web-Based In-Motion Display System for Vehicles, People and Objects,” filed on May 23, 2003, by inventors Roman Smolgovsky and Maurice Bailey.

### TECHNICAL FIELD

This invention relates generally to the display of data, and more particularly, but not exclusively, provides a system and method for displaying graphical and textual data in layers.

### BACKGROUND

Conventionally, to display moving objects in a web browser, the browser has to be refreshed at regular intervals, in which a user's screen will temporarily go blank and then display new data. This is true even if only one object from a plurality of objects is moving. This is not only disruptive to the user but also may require significant data transfers even though only a subset of data is actually changing. While there are some solutions to this issue—, such as Java Applets, ActiveX controls, Macromedia Flash—the conventional solutions may not be always usable by all customers because of configuration/security/etc. issues. In addition, not all customers will require the same data to be displayed (e.g., one customer may require weather displayed while another customer may only require aircraft to be displayed). Therefore, a new system and method are needed that enable the display of objects regardless of the client's capabilities and based on the client's data requirements. The new system and method should also enable the displaying of moving objects without having to refresh an entire display screen and that further enables the changing display of subsets of data without disturbing or requiring redisplay of other non-changing data.

### SUMMARY

Embodiments of the invention enable the generating of an image of moving and static objects in positional relationship to other objects through the use of multiple layers that can be refreshed independently of each other.

In an embodiment of the invention, a system comprises a plurality of layers that are each communicatively coupled to a layers manager. Each layer, which acts independently from each other, gets at least one object from a data provider; and renders an image using the at least one object. The layers manager coordinates the rendered images to form a final image.

In an embodiment of the invention, a method comprises:

for each layer of a plurality of layers getting at least one object from a data provider; rendering an image using the at least one object. After the rendering, the method further comprises coordinating the rendered images to form a final image.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a unified modeling language (UML) class diagram illustrating a system according to an embodiment of the invention;

FIG. 2 is a UML sequence diagram illustrating a method of displaying multiple layers of mobile and immobile objects;

FIG. 3 is a block diagram illustrating an example computer capable of hosting nodes of the system;

FIG. 4 is a block diagram illustrating an aircraft situation display system for implementing the system of FIG. 1;

FIG. 5 is a block diagram illustrating an aircraft situation display system for implementing the system of FIG. 1; and

FIG. 6 is a block diagram illustrating an aircraft situation display system for implementing the system of FIG. 1.

### DETAILED DESCRIPTION OF THE ILLUSTRATED EMBODIMENTS

The following description is provided to enable any person having ordinary skill in the art to make and use the invention, and is provided in the context of a particular application and its requirements. Various modifications to the embodiments will be readily apparent to those skilled in the art, and the principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

Embodiments of the inventions enable the display of multiple layers and dimensions of moving and static objects on a plan, topology or a map without refreshing the browser. The data displayed may include, but is not limited to: vehicles, such as: ships; trains; planes; planned and actual aircraft routes; jet ways; airways; airports; runways; staff location; emergency personnel location;

weather, including clouds, Doppler radar, winds, and waves; cities; roads; and traffic congestion.

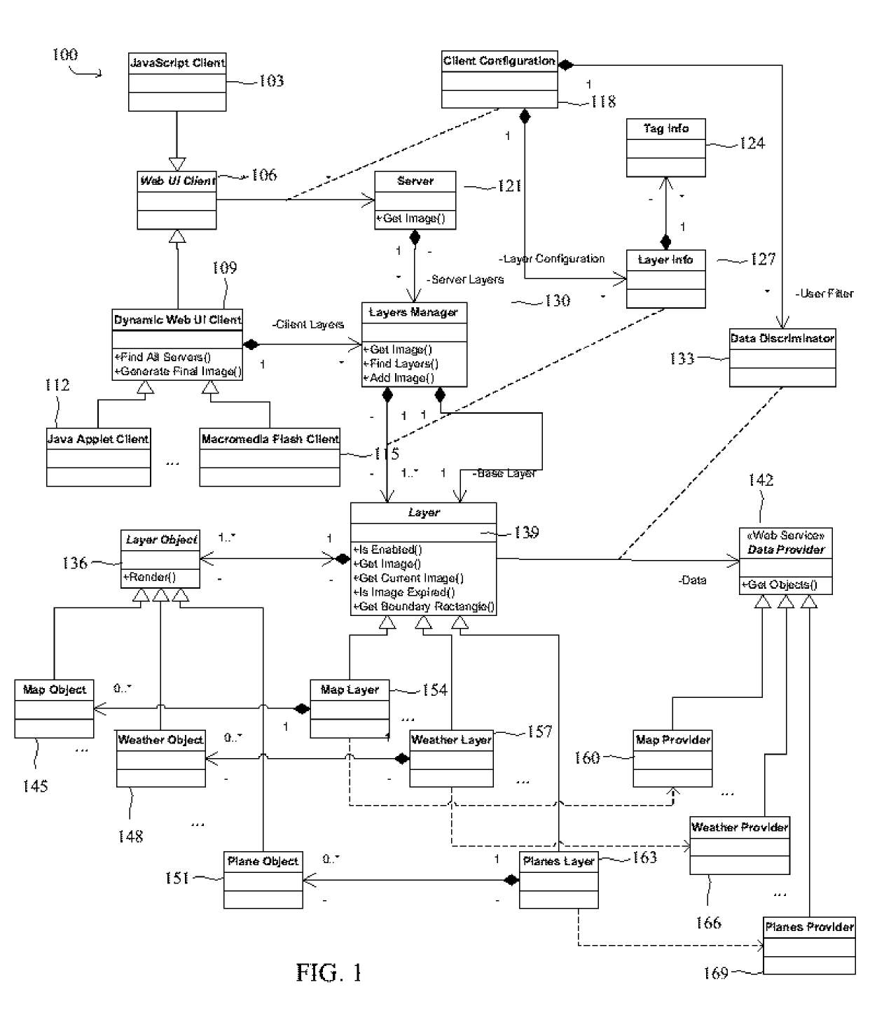

Imagery Updates are on-demand and automatic. Some of the data that a system 100 (FIG. 1) displays may be very time sensitive, e.g., position of an airplane that travels 400 mph should be automatically updated as often as possible. Other may be refreshed on-demand, for instance when user chooses to change the zoom level.

Multiple Layers of Data enables independent images generation. The system 100 can display multiple dimensions of data. For example, an aircraft situation display may include aircrafts, their routes, weather, airways and the geographical map of the region. The system 100 uses different layers to display different data—one layer will display aircrafts, next layer Doppler radar, next—weather satellite, an additional layer for airways, a separate layer for map, etc. Each layer is completely independent from the others. Accordingly, the system 100 can update the image of a single layer without touching others. For example, it is possible for the user to change the style of the map shown on the map layer, which will not affect the images of other layers given that the dimensions and resolution of the map stayed the same. The system 100 then combines the final image based on the images of each layer.

FIG. 1 is a UML class diagram illustrating the system 100 according to an embodiment of the invention. A Web client 106 implemented either using conventional Web Scripting techniques such as JavaScript client 103 or as Dynamic Client 109 that can independently run (Java Applet client 112, Macromedia Flash client 115 etc.), displays a plurality of layers of data. In an embodiment of the invention, the client 106 displays aviation-related data, such as a map in a first (or base) layer, aircraft positions (and related data) in a second layer, and weather data in a third layer.

The client 106 is in communication with a layers manager 130 that resides on a server 121. At the same time Dynamic Client 109 may contain its own Layer Manager; in an embodiment of the invention, the layer manager 130 can reside on the client 109 or both the client 109 and the server 121 can have layer managers 130. The layers manager 130 gets a layer 139 subject to restrictions from a data discriminator 133 based on data from a client configuration 118, which are both communicatively coupled to the layers manager 130.

The client configuration 118 includes any data that may be needed for filtering the information provided by a Data Provider 142; such data my include but is not limited to login data (that determines what data is available to the client 109 from a security perspective, e.g., user from a first company will be unable to see passenger information from a second company, and vice versa), license data (which determines what type or level of data will be available for viewing, e.g. a first license may enable display a passenger manifest for a vehicle while a second license may enable displaying of only vehicle information, such as position and velocity), local data (which defines the data a user of the client 109 has chosen to display, e.g., a geographical region or certain vehicles) and so on.

The above-mentioned data for client configuration 118 is stored in a layer info 127 and a tag info 124. The layer info 127 contains the information that is needed for a particular layer (such as update time, on/off, attributes of the objects and so on). The tag info contains information about the tags for the layer's objects, such as emergency data (e.g., 911 feeds, aircraft emergencies, etc.).

The layer 139 can have a plurality of implementations; such implementations may include, but not limited to a map layer 154, a weather layer 157, a planes layer 163 and so on. In another embodiment of the invention, the layer 139 can include additional classes such as a vehicle class, a traffic class, a city class, an emergency class (in place of tags) for 911 feeds, aircraft emergencies, law enforcement vehicles, vehicle accidents etc. (not shown), etc. Each layer 139 generates objects 136 based on data from a data provider 142 subject to the limitations of the data discriminator 142. In an embodiment, layer object 136 can include a map object 145, a weather object 148, and a plane object 151, which are generated by the map layer 154, the weather layer 157, and the planes layer 163, respectively. Each particular implementation of the layer 139 must obtain the data from a specific implementation of a Data Provider 142. Thus, the layers 154, 157 and 163 are each communicatively coupled to a particular implementation of data provider 142, such as a map provider 160, a weather provider 166, and a planes provider 169.

Objects displayed in the system 100, such as the objects 145, 148, and 151, may have attributes such as passengers traveling on a certain vehicle; name and title of security guard that is being tracked; detailed information about a cloud; positional information; etc. For example, the system 100 may receive the data about the flights from a feed based on FAA data and the data about their passengers—one of the attributes of the flight—based on parsing the travelers itinerary.

The system 100 uses tags for attributes display. Each object may have several types of tags associated with it; the tags may include but are not limited to a follow-up tag that moves together with the object and used for display of core attributes—a user can turn follow-up tags on/off and specify their layout; a short tag is displayed when user hovers the mouse over the object; and a full tag is displayed when users selects the object. The system 100 uses attributes for searching and locating objects. For example the system 100 is capable to locate a flight based on the selected passenger that travels on this flight.

During operation of the system 100, the client 109 passes data from the client configuration 118 to the layers manager 130. The layers manager 130 maintains a collection of layers 139 for each client 109 communicatively coupled to it. The layers manager 130 requests each layer 139 to generate its image based on the client configuration 118 data that is used by Data Discriminator 133 to limit the data that will be obtained from the Data Provider 142. As soon as all images are generated the layers manager 130 superimposes them thus generating the full image that is passed on the client 109. Each layer 139 contacts its corresponding data provider 142 in order to obtain the latest data. Every layer 139 has its own update rules—if the layer data is not expected to be refreshed yet the data is not updated.

Generating all the images when the changes are applicable only to one layer might be too expensive—that may take some time. At the same time, Dynamic Clients 109 may have quite extensive drawing capabilities. In order to speed up and often simplify the image updates, the system 100 enables Dynamic Clients to be able to maintain their own layers and update them directly without interacting with the layers manager 130 residing on the Server 121.

As soon as the layers manager 130 obtains all the images from all enabled layers 139 it generates the final picture that is sent to the client 106. In an implementation, Client 106 just displays the received image; however, Dynamic Client 109 receives the final image and, if needed generates the images from its layers. These images are added on top of the image that was received from the layers manager 130 and the final image is displayed on the client 109.

Every time the image needs to be refreshed the system 100 determines which layers 139 are affected and refreshes only these layers. The Dynamic Client 109 maintains all of the ‘fast’ layers internally.

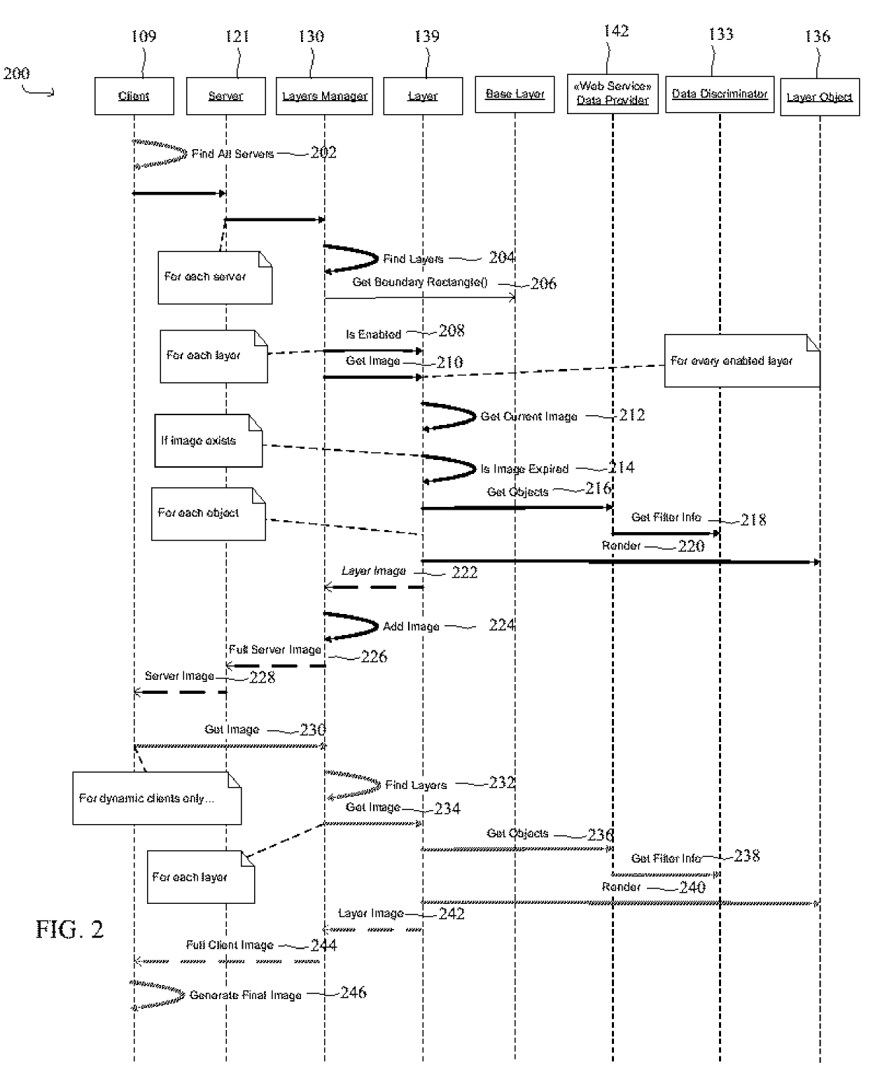

FIG. 2 is a sequence diagram illustrating a method 200 of displaying multiple layers of mobile and immobile objects. First a client 109 finds all available servers 121 (202). For each server 121, the layer manager 130 finds (204) all layers 139. A boundary rectangle is then calculated (206) per data in the client configuration 118. For each layer that is enabled (208), the layers manager 130 gets (210) an image.

Getting (210) an image for a layer comprises getting (212) a current image. If the current image is expired (214), then the layer 139 gets (216) objects from the data provider 142 and gets (218) filter info from the data discriminator 133. The layer 139 then renders (220) the image for objects per the filter info. The layer 139 then returns (222) the image to the layer manager 139, which adds (224) the returned image to other returned images (if any) to form (226) a full server image, which is returned (228) to the client 109. The final image is generated by combining the rendered images in a coordinated fashion based on objects positional data relative to a base layer (e.g., map layer). The method 200 then ends.

In another embodiment of the invention, for dynamic clients, first, the client 109 gets (230) an image from the layers manager 130. Getting (230) comprises finding layers (232), getting (234) an image for each found layer, which comprises getting (236) objects for each layer, getting (238) filter information from the data discriminator 133, and then rendering (240) the image using the objects and based on the filter information. The layer 139 then passes (242) the rendered image to the layers manager 130, which passes (244) it to the client 109, which generates (246) the final image by combining the rendered images in a coordinated fashion based on objects positional data relative to a base layer (e.g., map layer).

For panning and zooming, a lowest layer defined in the system serves as a Base Layer for panning and zooming (e.g., the map layer 154). The system 100 employs the following algorithm to pan/zoom:

User pans/zooms the whole image;

Pan/Zoom is performed for Base Layer—the ‘lowest’ layer in the layers stack;

New boundary rectangle coordinates are calculated;

All other layers are redrawn based on new boundary rectangle;

The system 100 enables users to pan the combined image in any of 8 directions with multiple ‘panning speeds’—there are multiple values for pan jump. Zooming is implemented based on the resolution of the Base Layers—dependently on resolution of the data currently shown in the layer the zoom values might be different. That feature becomes very important when the Base Layer used for displaying of different styles of geographical maps—resolution capabilities of the maps may vary based on the map style. To solve this problem the system 100 supports multiple resolutions for the layer based on the map style—for instance for US Details, Zoom levels 1-5 may correspond to 10, 100, 200, 500 and 1000 miles while for World Topography map same levels may translate to 100, 250, 500, 1000 and 2000 miles.

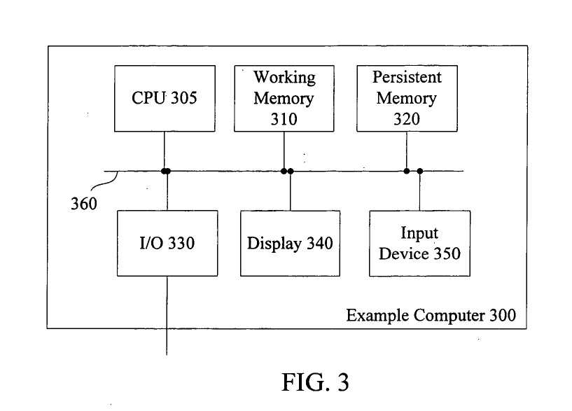

FIG. 3 is a block diagram illustrating an example computer 300 capable of hosting nodes of the system 100. In an embodiment of the invention, the client 109, server 121, layers manager 130, data provider 142, etc. may include or be resident on a computer that is substantially similar to example computer 300. The example computer 300 includes a central processing unit (CPU) 305; working memory 310; persistent memory 320; an input/output (I/O) interface 330; a display 340 and an input device 350, all communicatively coupled to each other via a system bus 360. The CPU 305 may include an Intel PENTIUM® microprocessor, a Motorola POWERPC® microprocessor, or any other processor capable to execute software stored in the persistent memory 320. The working memory 310 may include random access memory (RAM) or any other type of read/write memory devices or combination of memory devices. The persistent memory 320 may include a hard drive, read only memory (ROM) or any other type of memory device or combination of memory devices that can retain data after example computer 300 is shut off. The I/O interface 330 is communicatively coupled, via wired or wireless techniques, to other nodes, via a network, such as the Internet. The display 340 may include a cathode ray tube display or other display device. Input device 350 may include a keyboard, mouse, card reader or other device for inputting data, or a combination of devices for inputting data.

One skilled in the art will recognize that the example computer 300 may also include additional devices, such as additional network connections, additional memory, additional processors, LANs, input/output lines for transferring information across a hardware channel, the Internet or an intranet, etc. One skilled in the art will also recognize that the programs and data may be received by and stored in the system in alternative ways.

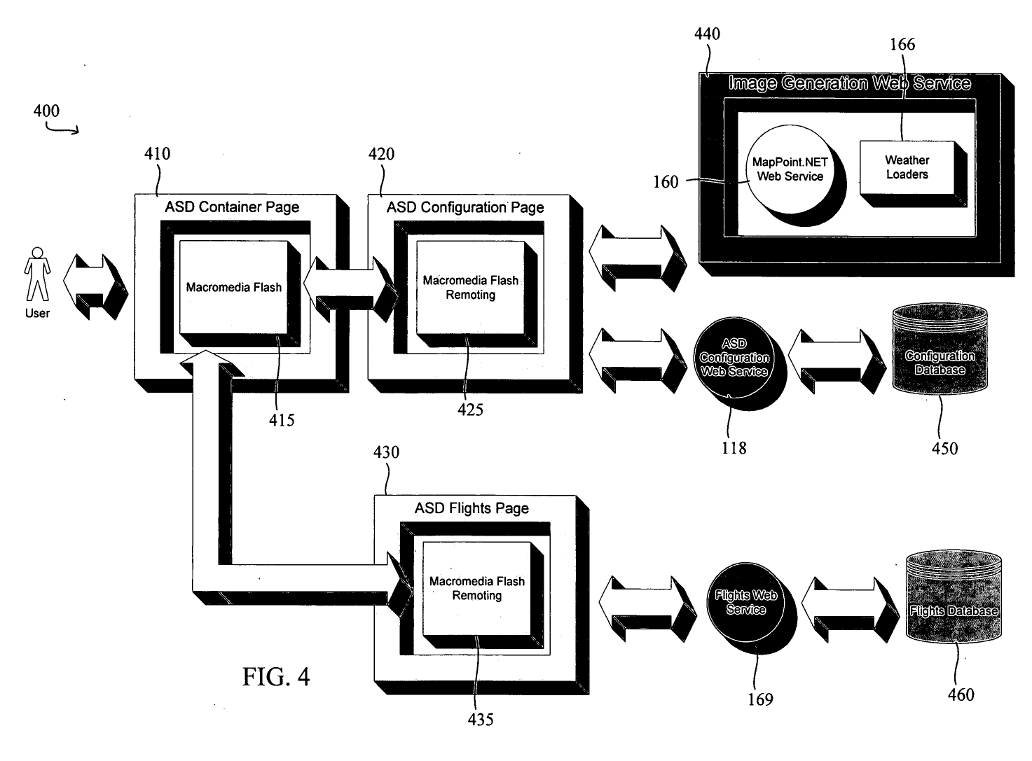

FIG. 4 is a block diagram illustrating an aircraft situation display system 400 for implementing the system 100 (FIG. 1). The system 400 includes an Aircraft Situation Display (ASD) Container Page 410 communicatively coupled to an ASD Configuration Page 420 and an ASD Flights Page 430. The ASD configuration page 420 is communicatively coupled to an image generation web service 440 (comprising a map service 160 and a weather loader 166). The ASD configuration page 420 is also communicatively coupled to an ASD configuration web service 118, which is communicatively coupled to a configuration database 450. The ASD flights page 430 is also communicatively coupled to a flight web service 169, which is communicatively coupled to a flights database 460.

The ASD container page 410 includes Macromedia Flash Client 415 that generates a display based on data received from a Macromedia Flash Remoting 425 and 435 in the ASD configuration page 420 and the ASD flights page 430, respectively.

Based on a user's configuration, the layers manager 130 (ASD Configuration page 420) obtains a full image with weather that is returned to the client as a bitmap image. The image is generated based on the data received from two Data Providers—Map Point NET Web Service 160 for the map itself and the Weather Loaders Service 166 used for loading Satellite and Radar images. The client maintains the planes image locally—Planes layer 163 (ASD Flights Page 430) obtains the needed flights information from the Flights Web Service Data Provider 169 and generates the flight image internally.

A user enters login identification and map center identification to the ASD container page 410, which communicates with the ASD configuration page 420. The ASD configuration page 420 transmits login ID and map center ID to the ASD configuration web service 118, which transmits back zoom, pan, weather on/off, planes on/off, plane tags on/off, filters, and lists. The ASD configuration page 420 then transmits map type, zoom, pan, weather on/off, to the image generation web service 440, which generates a full map image with weather, which is sent back to the ASD configuration page 420 for display to the user.

The ASD flights page transmits filters, lists (of aircraft) and coordinates of a bounding rectangle (map boundaries) to the flight web service 169, which accesses a flight database 460 for flight information corresponding the aircraft in the lists and within the boundaries specified by the bounding rectangle. The flights web service 169 returns flight data to the ASD flights page 430, which then generates an image incorporating the flight data for display to the client. Macromedia flash client then combines and displays images from the image generation web service 440 and flights web service 169. Each layer of the image can then be updated independently. For example, a map need not be updated as topography is unchanging (i.e., the map image would only be updated if a user wanted to view a different section or range of a map) while flight data would be updated regularly due to the high velocity of aircraft.

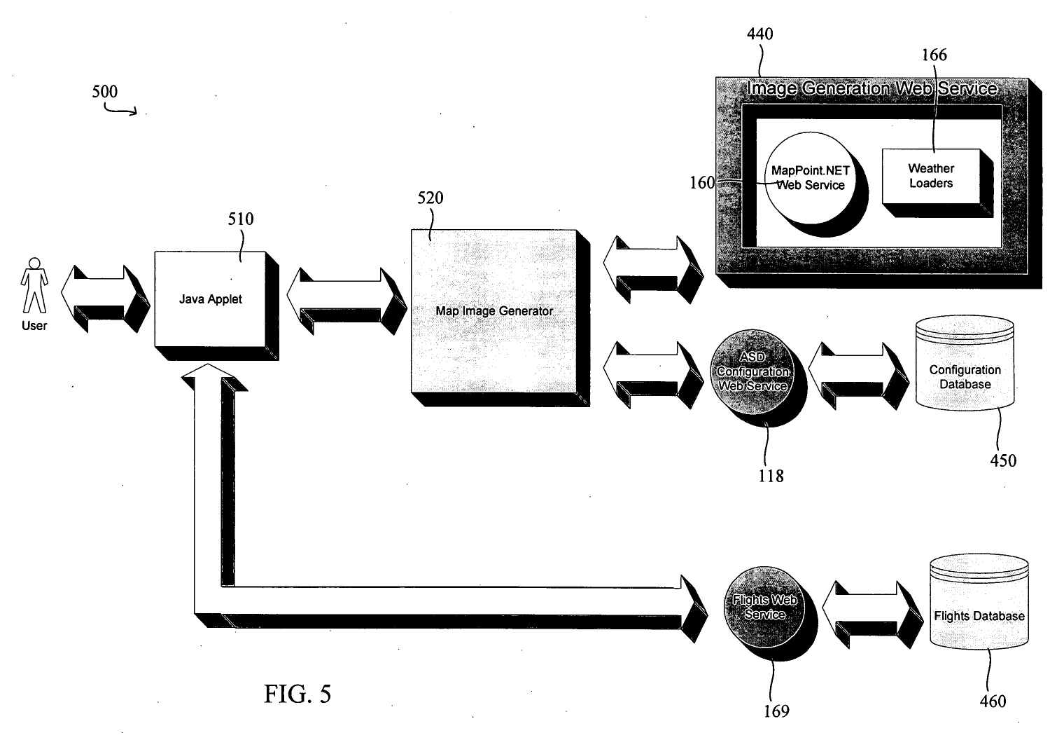

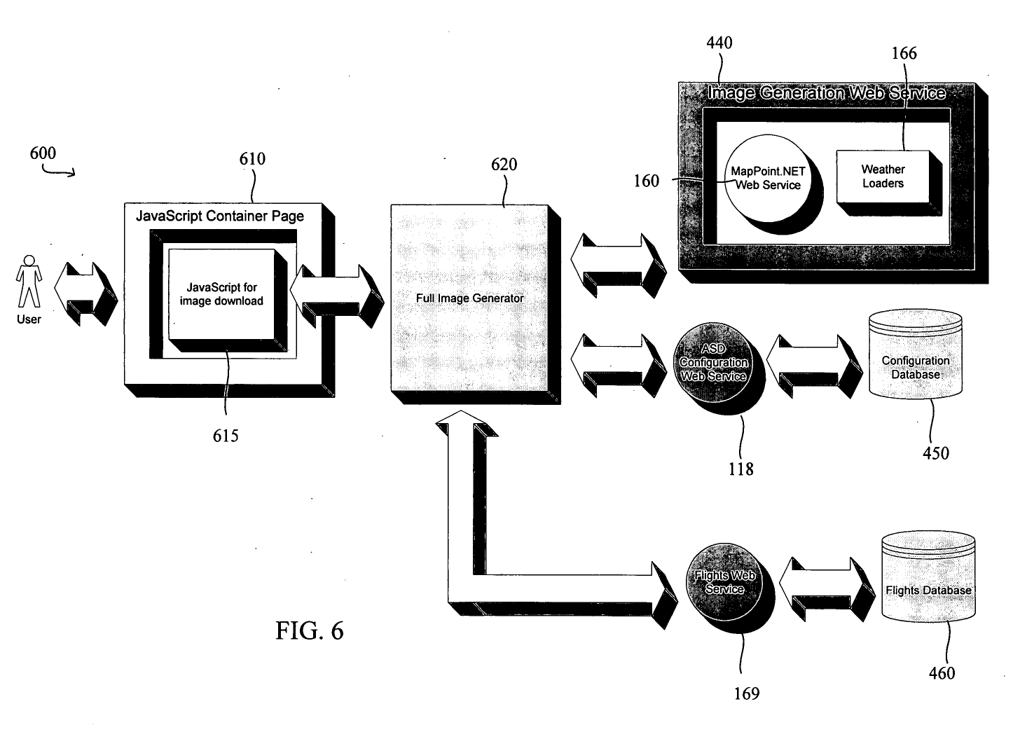

The ASD system 400 can also be implemented using Java Applet and JavaScript clients, as shown in FIG. 5 and FIG. 6, respectively. A JavaScript client 615 in incapable of drawing aircraft objects and therefore, a full image generator 620 is required that generates images from the map provider 160, weather provider 166 and planes provider 169.

In an embodiment of the invention, each object in image layer can have associated data that is displayed in a tag of the object. For example, an aircraft object can have a flight number, velocity, ETA, a passenger manifest, emergency data, and other data that is provided by the planes provider 169. A weather object, such as a storm cloud, can have associated weather data including storm severity, type of precipitation (e.g., hail, rain, snow, etc.), etc. that is provided by the weather provider 163. A map object, such as a city, can have associate data such as city name, population, etc. that is provided by the map provider. Other objects can include other data provided by their respective data providers.

The foregoing description of the illustrated embodiments of the present invention is by way of example only, and other variations and modifications of the above-described embodiments and methods are possible in light of the foregoing teaching. Although the network sites are being described as separate and distinct sites, one skilled in the art will recognize that these sites may be a part of an integral site, may each include portions of multiple sites, or may include combinations of single and multiple sites. Further, components of this invention may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

1. A web-based method for generating an image of moving and static objects in positional relationship to other objects, comprising:
for each layer of a plurality of layers getting at least one object from a data provider;
rendering an image using the at least one object; and
coordinating the rendered images to form a final image;
wherein each layer of the plurality of layers is independent of each other.

2. The method of claim 1, wherein the moving objects includes aircraft, emergency vehicles, accident locations and law enforcement vehicles.

3. The method of claim 1, wherein the plurality of layers includes an aircraft layer, a weather layer, emergency data layer, and a map layer.

4. The method of claim 1, wherein each layer of the plurality of layers is associated with a separate data provider.

5. The method of claim 1, further comprising:
calculating a boundary for a base layer of the plurality of layers, the base layer including a map layer; and
wherein the getting for each of the other plurality of layers gets objects within the boundary.

6. The method of claim 1, wherein the getting is subject to permissions of a user.

7. The method of claim 6, wherein the permissions include security permissions, license permissions, and local permissions.

8. The method of claim 1, further comprising displaying the final image.

9. The method of claim 1, wherein each of the layers independently refreshes itself.

10. The method of claim 9, wherein the refreshing of one layer does not influence other layers.

11. The method of claim 1, wherein each of the layers can be independently turned on or off.

12. The method of claim 1, wherein each of the layers determines if it needs to be redrawn.

13. The method of claim 1, wherein the rendering can be performed on both a client and on a server.

14. The method of claim 1, wherein one of the plurality of layers includes an emergency data layer.

15. The method of claim 1, wherein each object has a tag associated with the object.

16. The method of claim 15, wherein the tag includes emergency data.

17. A web-based system for generating an image of moving and static objects in positional relationship to other objects, comprising:
for each layer of a plurality of layers means for getting at least one object from a data provider;
means for rendering an image using the at least one object; and
means for coordinating the rendered images to form a final image;
wherein each layer of the plurality of layers is independent of each other.

18. A computer-readable medium having stored thereon instructions to cause a computer to execute a web-based method for generating an image of moving and static objects in positional relationship to other objects, the method comprising:
for each layer of a plurality of layers getting at least one object from a data provider;
rendering an image using the at least one object; and
coordinating the rendered images to form a final image;
wherein each layer of the plurality of layers is independent of each other.

19. A web-based system for generating an image of moving and static objects in positional relationship to other objects, comprising:
a plurality of layers, each layer capable of getting at least one object from a data provider;
rendering an image using the at least one object; and
a layers manager, communicatively coupled to each of the plurality of layers, capable of coordinating the rendered images to form a final image;
wherein each layer of the plurality of layers is independent of each other.

20. The system of claim 19, wherein the moving objects include aircraft, law enforcement vehicles, emergency locations and emergency vehicles.

21. The system of claim 19, wherein the plurality of layers includes an aircraft layer, a weather layer, an emergency data layer and a map layer.

22. The system of claim 19, wherein each layer of the plurality of layers is associated with a separate data provider.

23. The system of claim 19, wherein the layers manager is further capable of calculating a boundary for a base layer of the plurality of layers, the base layer including a map layer; and wherein the each of the plurality of layers gets objects within the boundary.

24. The system of claim 19, wherein the layers get objects subject to permissions of a user.

25. The system of claim 24, wherein the permissions include security permissions, license permissions, and local permissions.

26. The system of claim 19, further comprising a client, communicatively coupled to the layers manager, capable of displaying the final image.

27. The system of claim 19, wherein each of the layers independently refreshes itself.

28. The system of claim 28, wherein the refreshing of one layer does not influence other layers.

29. The system of claim 19, wherein each of the layers can be independently turned on or off.

30. The system of claim 19, wherein each of the layers determines if it needs to be redrawn.

31. The system of claim 19, wherein the layers manager can reside on both a client and on a server.

32. The system of claim 19, wherein one of the plurality of layers includes an emergency data layer.

33. The system of claim 19, wherein each object has a tag associated with the object.

34. The system of claim 33, wherein the tag includes emergency data.
